(19) United States
(12) Patent Application Publication
(10) Pub. No.: US 2011/0197572 A1
(43) Pub. Date: Aug. 18, 2011

(54) SMART EXHAUST GAS FLOW CONTROL APPARATUS

(75) Inventor: MING-TIEN CHANG, Fen-Yuan Hsiang (TW)

(73) Assignee: LIANG FEI INDUSTRY CO., LTD., Fen-Yuan Hsiang (TW)

(21) Appl. No.: 12/704,758

(22) Filed: Feb. 12, 2010

(51) Int. Cl. F01N 1/00; F16K 31/12; G06F 19/00

(52) U.S. Cl. 60/324; 251/12; 701/2

(57) ABSTRACT

A smart exhaust gas flow control apparatus comprises at least a control unit, a solenoid valve, a vacuum auxiliary storage tank, a valve located on an auxiliary exhaust pipe, a sensor set and an operation interface. The control unit receives control commands from the operation interface to control opening and closing of the valve to select an exhaust gas path according to requirements to discharge exhaust gas, thus can avert traffic jam caused by too slow of vehicle speed and can adjust exhaust gas flow amount according to different road conditions.

### BACKGROUND OF THE INVENTION

1. Field of the Invention

The present invention relates to a smart exhaust gas flow control apparatus and particularly to an apparatus that contains exhaust gas paths selectable according to requirements to avert traffic jam caused by slower vehicle speed and adjustable exhaust gas flow according to different road conditions.

2. Description of the Prior Art

Exhaust gas discharge conditions in vehicles affects engine running efficiency. On the general diesel engine vehicle exhaust gas discharge problem caused by carbon clogging in the catalyst converter often results in dropping of engine efficiency and slow down of vehicle speed. In urbane area such a problem causes serious traffic jam. Moreover, regulations on noise, exhaust gas pollution and speed of motor vehicles are different in urban areas and suburbs. Driver's requirements for motor power and feeling also are different. All this has some relations with exhaust gas flow of the exhaust pipe. For instance, climbing a hill at country site requires enhanced acceleration and power, hence must have more exhaust gas flow to meet actual requirement. Diving in city area demands lower noise and pollution, thus exhaust gas discharge is restricted. The conventional exhaust pipe has a fixed amount of exhaust gas discharge and cannot be dynamically adjusted to suit driving requirements of different road conditions. Although adjustable exhaust pipe has long been developed and introduced in the industry, it still has a big drawback, i.e. the driver has to stop the vehicle and get off the car to adjust the exhaust gas flow of the exhaust pipe with a tool, and is inconvenient and troublesome. To remedy this problem, Applicant has proposed a technique disclosed in U.S. Pat. No. 6,598,390. It includes a controller to control open and close of a valve. It greatly improves usability over the conventional manual approach. But it still does not provide fully automatic control. There is room for improvement.

### SUMMARY OF THE INVENTION

In view of the aforesaid problem, the present invention aims to provide a smart exhaust gas flow control apparatus that provides exhaust gas paths selectable according to requirements to avert traffic jam caused by slower vehicle speed and adjustable exhaust gas flow according to different road conditions.

To achieve the foregoing object the present invention comprises at least a control unit, a solenoid valve, a vacuum auxiliary storage tank, a valve located on an auxiliary exhaust pipe, a sensor set and an operation interface. The control unit receives control commands from the operation interface to control open and close of the valve to discharge gas according a selected exhaust gas path based on requirements.

The operation interface is located on a vehicle body (such as steering wheel or dashboard), and includes at least a manual control button and an automatic control button.

In one aspect, the operation interface is a remote controller, and includes at least a manual control button and an automatic control button.

The control unit performs automatic control based on at least one detection value provided by the sensor set. The sensor set contains a first sensor to detect the cam shaft RPM (rotation per minute) of a vehicle engine.

The control unit, aside from performing automatic control based on the detected value of the first sensor, also has a second sensor to detect exhaust gas flow amount discharged by an exhaust pipe set.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a structural block diagram of the invention.

FIG. 2 is a schematic view of the invention showing the auxiliary exhaust pipe in a closed condition.

FIG. 3 is a schematic view of the invention showing the auxiliary exhaust pipe in an open condition.

FIG. 4 is an exploded view of the valve of the invention.

FIG. 5 is a schematic view of the invention showing the valve in closed condition-1.

FIG. 6 is a schematic view of the invention showing the valve in closed condition-2.

FIG. 7 is a schematic view of the invention showing the valve in open condition-1.

FIG. 8 is a schematic view of the invention showing the valve in open condition-2.

FIG. 9 is a schematic view of another embodiment of the invention in operating condition-1.

FIG. 10 is a schematic view of another embodiment of the invention in operating condition-2.

FIG. 11 is a schematic view of another embodiment of the operation interface of the invention

### DESCRIPTION OF THE PREFERRED EMBODIMENTS

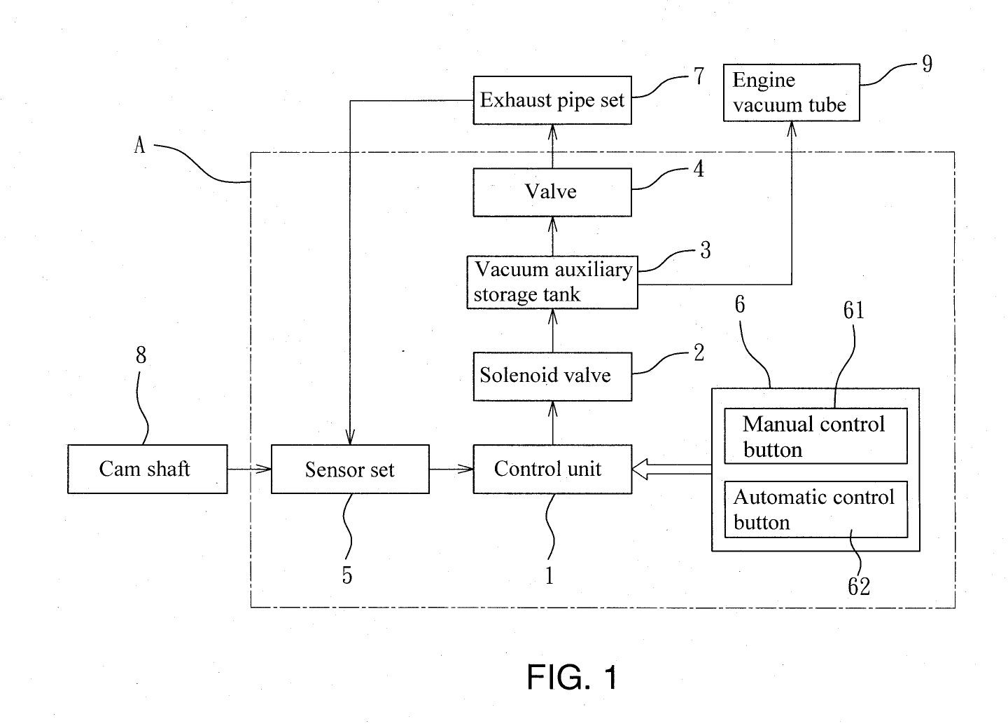

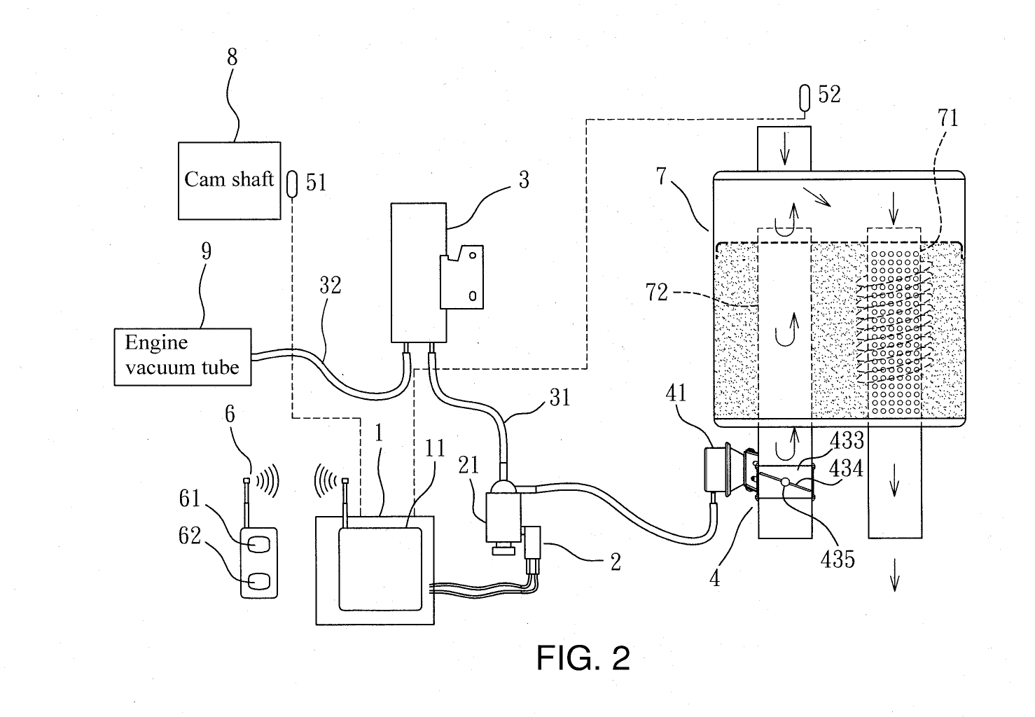

Please refer to FIG. 1 for the structural block diagram of the invention (also refer to FIG. 2 for an embodiment of the invention). The present invention aims to provide a smart exhaust gas flow control apparatus A which comprises at least a control unit 1, a solenoid valve 2, a vacuum auxiliary storage tank 3, a valve 4, a sensor set 5 and an operation interface 6.

The control unit 1 provides comparison, process and memory functions, and receives detection values from the sensor set 5 and control signals from the operation interface 6 to control operation of the solenoid valve 2.

The solenoid valve 2 receives the control signals from the control unit 1 to change valve position for opening or closing.

The vacuum auxiliary storage tank 3 is a closed tank and forms a negative interior pressure, and is coupled with a first connection tube 31 and a second connection tube 32. The first connection tube 31 has another end connecting to an engine vacuum tube 9 of a vehicle. The second connection tube 32 is connected to the solenoid valve 2 and has another end connecting to the valve 4 (referring to FIG. 2).

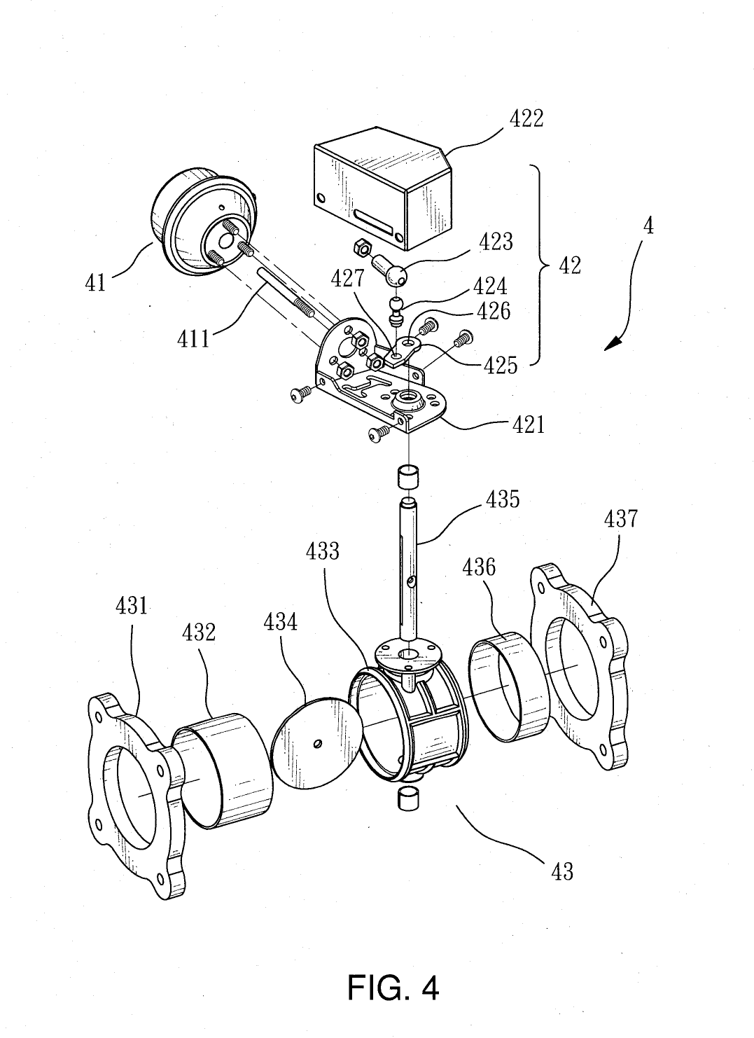

The valve 4 is located on an auxiliary exhaust pipe 72 of an exhaust pipe set 7, and includes a valve holder 43 connecting to an adapter box 42 and a vacuum valve 41 (referring to FIG. 4). The valve holder 43 has a throttle plate 434 movable in a throttle duct 433 to control exhaust gas flow paths.

The sensor set 5 includes at least one sensor.

The operation interface 6 aims to enter the control signals to the control unit 1 to drive the solenoid valve 2 to switch valve position to control open and close of the valve 4. It has at least a manual control button 61 and an automatic control button 62.

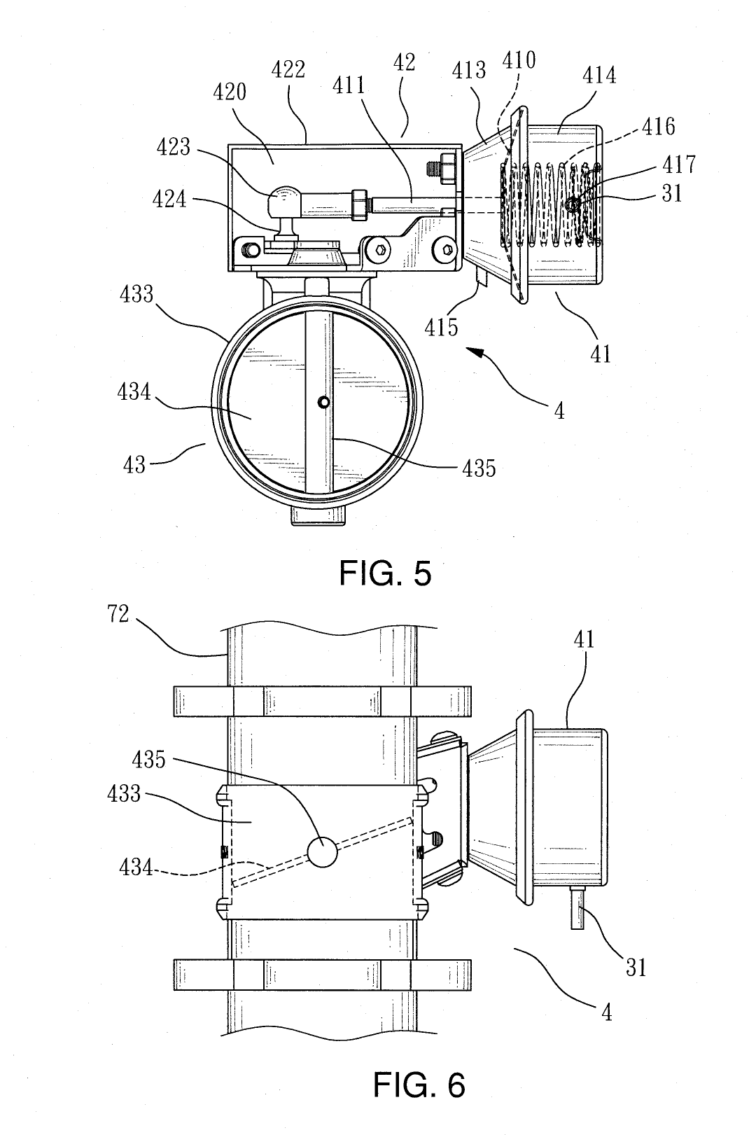

Referring to FIG. 4, the valve holder 43 includes a left holding plate 431, a left coupling duct 432, the throttle duct 433, a right coupling duct 436 and a right holding plate 437 in this order. The throttle plate 434 is held in the throttle duct 433 and controlled by a control bar 435 to control whether exhaust gas to pass through the throttle duct 433. The adapter box 42 of the valve 4 includes a base 421 and a casing 422 to form a chamber 420 inside (referring to FIG. 5) to house a first fastening hole 426 of a picking blade 425 coupled on an upper section of the control bar 435. The picking blade 425 has a second fastening hole 427 coupled on a lower section of a second strut 424. The second strut 424 has an upper section fastened to a first strut 423. The vacuum valve 41 is divided by a membrane 410 to form a front chamber 413 and a rear chamber 414. The membrane 410 has one side connected to an action bar 411 which runs through the front chamber 413 to connect to the first strut 423. The rear chamber 414 houses a spring 416 inside and has an aperture 417 connecting to the first connection tube 31. The front chamber 413 further has a gas discharge orifice 415.

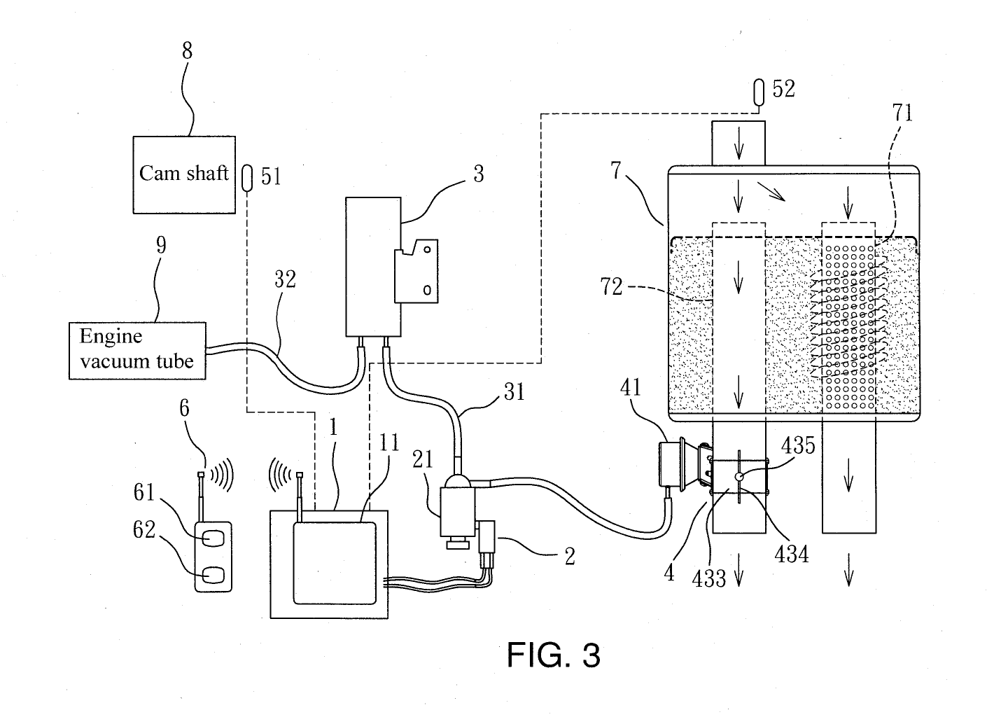

By means of the structure set forth above, in the event that a greater amount of exhaust gas flow is needed on the exhaust pipe set 7 or carbon clogging occurred to a main exhaust pipe 71, the valve 4 on the auxiliary exhaust pipe 72 has to be opened to allow the exhaust gas to pass through the auxiliary exhaust pipe 72 (referring to FIG. 3) corresponding to the adjusted exhaust gas path. Operation can be controlled in three approaches:

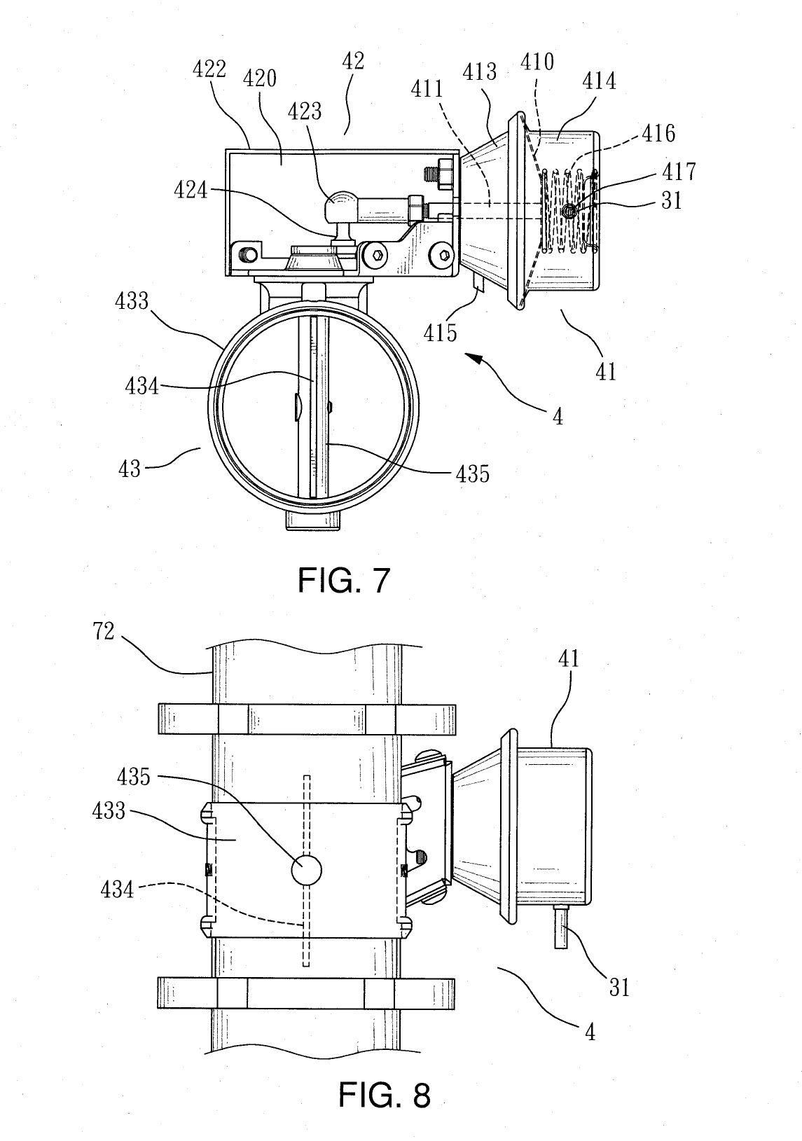

1. Push the manual control button 61 on the operation interface 6 to send an open (ON) signal to the control unit 1. The control unit 1 receives the signal, then drives the solenoid valve 2 to move a flow divider 21 to an open position. Meanwhile, air in the vacuum auxiliary storage tank 3 is drawn out through the first connection tube 31 and the rear chamber 414 of the vacuum valve 41 due to the negative pressure; the membrane 410 compresses the spring 416 to move the action bar 411, first strut 423, second strut 424 and picking blade 425 so that the control bar 435 rotates to open the throttle plate 434 (ON) as shown in FIGS. 3, 7 and 8 to allow the exhaust gas to be discharged through the auxiliary exhaust pipe 72.

2. By pushing the automatic control button 62 on the operation interface 6 an open (ON) signal can be sent to the control unit 1. The control unit 1, based on the detected value (namely the RPM of the cam shaft 8) obtained by the first sensor 51 at that moment, sets that when the current and upcoming vehicle speed has reached that RPM the control unit 1 automatically drives the solenoid valve 2 to control the flow divider 21 to move the valve at the open position. Other processes are same as those discussed at item 1 above, including the vacuum auxiliary storage tank 3 interacts with the vacuum valve 41 to open (ON) the throttle plate 434.

3. By pushing the automatic control button 62 on the operation interface 6 another open (ON) signal can be sent to the control unit 1. The control unit 1, based on the detected value (i.e. the exhaust gas flow amount of the exhaust pipe set 7) obtained by the second sensor 52 at that moment, sets that when the current and upcoming exhaust gas flow amount has reached that amount the control unit 1 automatically drives the solenoid valve 2 to control the flow divider 21 to move the valve at the open position. Other processes are same as those discussed at item 1 above, including the vacuum auxiliary storage tank 3 interacts with the vacuum valve 41 to open the throttle plate 434 (ON).

When the automatic control button 62 is pushed to open and discharge the exhaust gas through the auxiliary exhaust pipe 72, the control unit 1 automatically sets and remember the detected value measured at that moment. The detected value serves as a setting value. Thereafter, whenever the RPM or exhaust gas discharge amount has reached that setting value the valve 4 will be automatically opened (ON). If to change the vehicle speed or exhaust gas amount is desired, push the automatic control button 62 again, the process of executing and memorizing a new set value is performed.

When the manual control button 61 is pushed to close (OFF) or the vehicle speed or exhaust gas flow amount does not reach the set value, the control unit 1 drives the solenoid valve 2 to control the flow divider 21 to move the valve at the closed (OFF) position. As the membrane 410 and spring 416 in the vacuum valve 41 are no longer subject to the action of the negative vacuum pressure, the spring 416 provides a return elastic force to drive the membrane 410, action bar 411, first strut 423, second strut 424 and picking blade 425 to move the control bar 435 to rotate in the reverse direction so that the throttle plate 434 is moved to a closed (OFF) condition, and the path of the auxiliary exhaust pipe 72 also is closed (referring to FIGS. 2, 5 and 6); meanwhile the air in the front chamber 413 of the vacuum valve 41 is discharged through the gas discharge orifice 415.

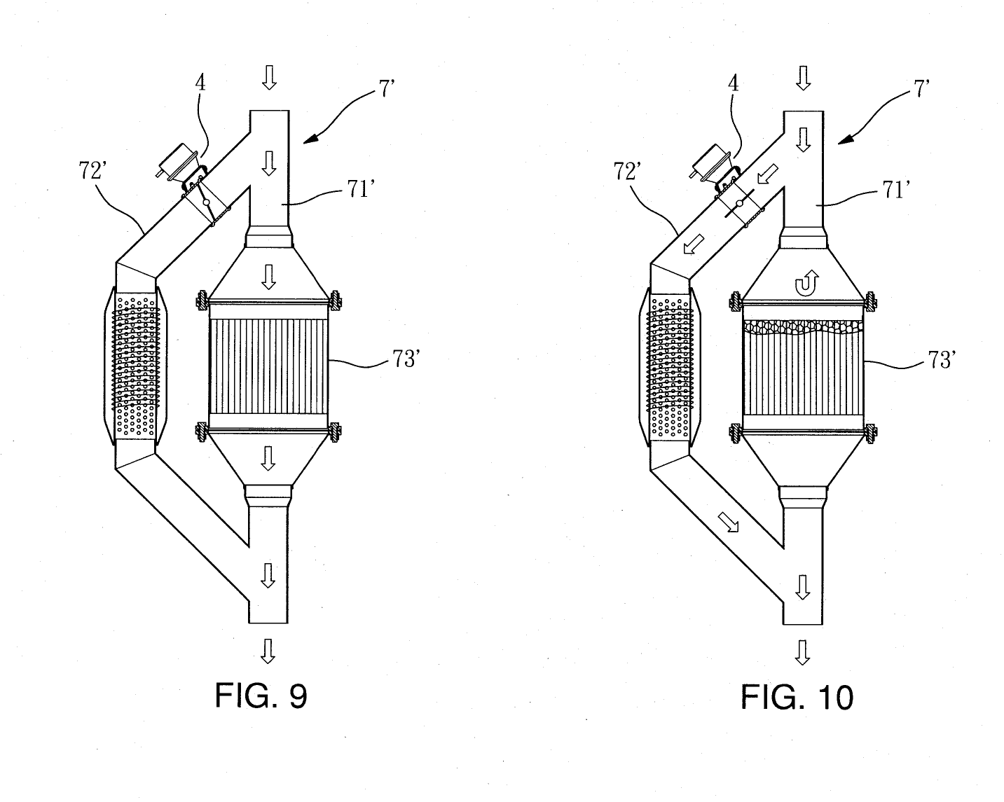

Please refer to FIGS. 9 and 10 for an embodiment of the invention adopted for use on a diesel vehicle. It includes an exhaust pipe set 7′ with a main exhaust pipe 71′ and a catalyst converter 73′ located thereon to filter out impurities in the exhaust gas and eliminate noise. It also has an auxiliary exhaust pipe 72′ with a valve 4 located thereon. FIG. 9 shows a general exhaust gas discharge condition. In the event that exhaust gas discharge difficulty takes place or in a road outside city area, the auxiliary exhaust pipe 72 discussed in the previous embodiment and shown in FIGS. 2 and 3 can be activated to discharge the exhaust gas. The technical measure is same as the previous embodiment, thus details are omitted here.

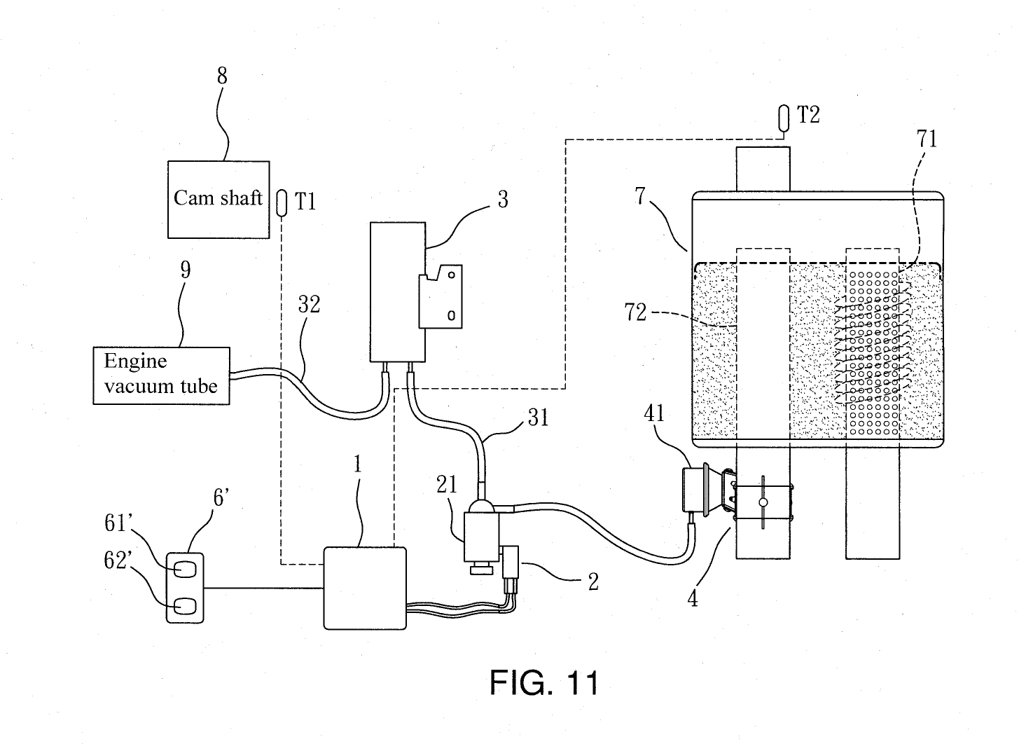

The operation interface 6 of the invention may also be implemented in a wireless fashion (referring to FIG. 2). In such an environment the operation interface 6 is a remote controller. The control unit 1 contains a signal receiver 11 to receive the control signals sent by the operation interface 6. Moreover, referring to another embodiment shown in FIG. 11, the operation interface 6′ may also be connected to the control unit 1 through line connection. The control signals sent by the operation interface 6′ through the manual control button 61′ or automatic control button 62′ can control operation of the control unit 1. The operation interface 6′ is preferably located on the steering wheel or dashboard.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

I claim:

1. A smart exhaust gas flow control apparatus comprising at least a control unit, a solenoid valve, a vacuum auxiliary storage tank, a valve, a sensor set and an operation interface, wherein:
the control unit receives detected values from the sensor set and control signals from the operation interface to control operation of the solenoid valve;
the solenoid valve receives the control signals from the control unit to change valve position for opening or closing;
the vacuum auxiliary storage tank is a closed tank and forms a negative interior pressure, and is coupled with a first connection tube and a second connection tube, the first connection tube having another end connecting to an engine vacuum tube of a vehicle, the second connection tube being connected to the solenoid valve and having another end connecting to the valve;
the valve is located on an auxiliary exhaust pipe of an exhaust pipe set and includes a valve holder connecting to an adapter box and a vacuum valve, the valve holder having a throttle plate movable in a throttle duct to control exhaust gas flow paths;
the sensor set includes at least one sensor; and
the operation interface accepts entry of control signals to the control unit to drive the solenoid valve to change valve position for opening or closing of the valve.

2. The smart exhaust gas flow control apparatus of claim 1, wherein the operation interface includes at least a manual control button and an automatic control button.

3. The smart exhaust gas flow control apparatus of claim 1, wherein the operation interface is a remote controller and the control unit contains a corresponding signal receiver.

4. The smart exhaust gas flow control apparatus of claim 1, wherein the sensor set includes a first sensor to detect rotation speed of a cam shaft of a vehicle engine.

5. The smart exhaust gas flow control apparatus of claim 1, wherein the sensor set includes a second sensor to detect exhaust gas amount of an exhaust pipe set.
